(19) United States
(12) Patent Application Publication
(10) Pub. No.: US 2007/0247854 A1
(43) Pub. Date: Oct. 25, 2007

(54) Ceiling fan

(76) Inventor: Chao-Pao Lin, Taichung (TW)

Correspondence Address: BROWDY AND NEIMARK, P.L.L.C.;624 NINTH STREET, NW, SUITE 300, WASHINGTON, DC, 20001-5303, US

(21) Appl. No.: 11/488,774

(22) Filed: Jul. 19, 2006

(30) Foreign Application Priority Data
Apr. 21, 2006 (TW) 95114479

(51) Int. Cl. F21V 33/00

(52) U.S. Cl. 362/294; 362/147; 362/96

(57) ABSTRACT

A ceiling fan includes a mounting unit for fastening to a ceiling, a power unit, which has a motor fastened to the mounting unit and a fan member coupled to and rotatable by the motor, and a shade, which is fastened to the mounting unit to accommodate therein the power unit so as to kept the power unit from sight. The shade has a plurality of slots for guiding air flow induced by the fan member out of the shade.

### BACKGROUND OF THE INVENTION

1. Field of the Invention

The present invention relates to electric fans and more particularly, to a ceiling fan.

2. Description of the Related Art

A conventional ceiling fan comprises a mounting base, a connecting tube, a motor, and fan blades. This design of ceiling fan requires much installation space. Further, after installation in the ceiling, the fan blades are exposed to the outside, unable to cause a sense of beauty. Furthermore, there are ceiling fans equipped with lamps for illumination. Ceiling fans with lamps are big-sized and heavy, giving a stress to the user. Due to heavy weight, the mounting arrangement of ceiling fans with lamps must be well considered to prevent falling upon a natural catastrophe, for example, an earthquake or typhoon.

In addition, during the operation of a ceiling fan, the air flow induced by the fan blades of the ceiling fan may cause paper documents to fly away when one is working beneath of the ceiling fan.

### SUMMARY OF THE INVENTION

The present invention has been accomplished under the circumstances in view. It is one object of the present invention to provide a ceiling fan, which uses a detachable decorative shade to keep the parts from sight, so that the whole assembly of the ceiling fan causes a sense of beauty and the user can replace the detachable decorative shade with a different design when desired.

It is another object of the present invention to provide a ceiling fan, which guides air flow induced to stream obliquely downwards.

To achieve these objects of the present invention, the ceiling fan comprises a mounting unit for fastening to a ceiling; a power unit having a motor fastened to the mounting unit and a fan member coupled to and rotatable by the motor; and a shade having a shade body accommodating therein the power unit. The shade body of the shade has a plurality of slots for guiding air flow induced by the fan member out of the shade.

### BRIEF DESCRIPTION OF THE DRAWINGS

FIG. 1 is a perspective view of a ceiling fan in accordance with a first preferred embodiment of the present invention.

FIG. 2 is an exploded view of the ceiling fan in accordance with the first preferred embodiment of the present invention.

FIG. 3 is a perspective view of a ceiling fan in accordance with a second preferred embodiment of the present invention.

FIG. 4 is a perspective view of a shade for a ceiling fan in accordance with a third preferred embodiment of the present invention.

FIG. 5 is a perspective view of a ceiling fan in accordance with a fourth preferred embodiment of the present invention.

FIG. 6 is a sectional view of the ceiling fan in accordance with the fourth preferred embodiment of the present invention.

### DETAILED DESCRIPTION OF THE INVENTION

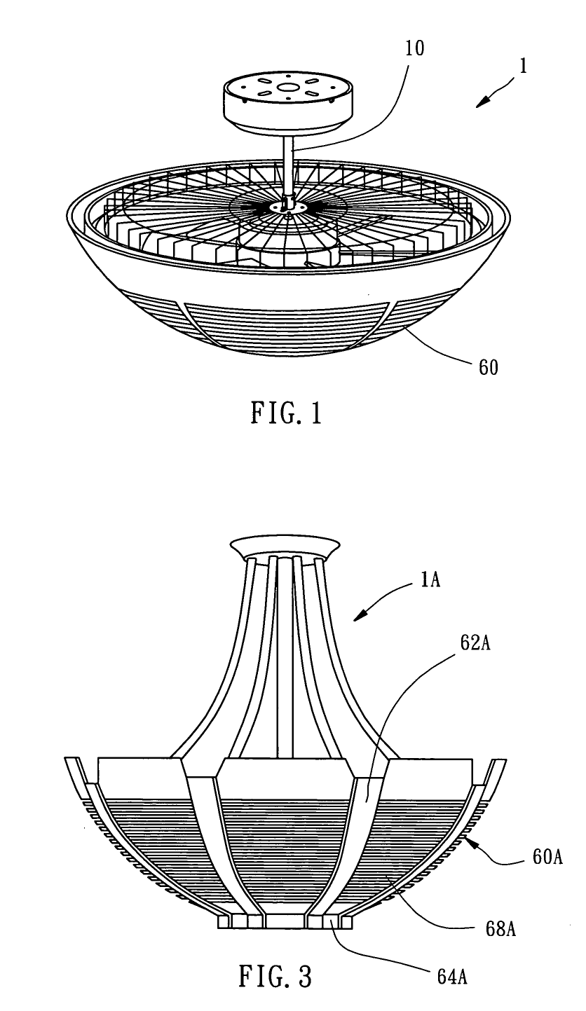

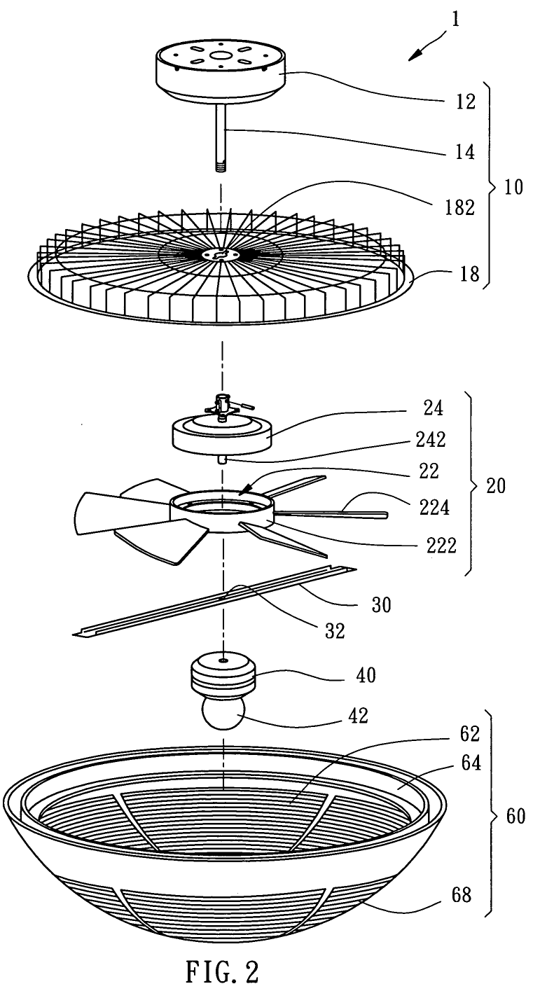

As shown in FIGS. 1 and 2, a ceiling fan 1 in accordance with a first preferred embodiment of the present invention comprises a mounting unit 10, a power unit 20, a rack 30, a lamp holder 40, and a shade 60.

The mounting unit 10 comprises a hanging member 12, a connecting tube 14, and a wire guard 18. The top side of the hanging member 12 is used to be fixedly fastened to the ceiling. The connecting tube 14 is fastened to the hanging member 12 and vertically downwardly extending through the bottom side of the hanging member 12. The wire guard 18 is fastened to the bottom end of the connecting tube 14, having a center coupling 182 coupled to the power unit 20.

The power unit 20 comprises a fan member 22 and a motor 24. The fan member 22 has a hub 222 coupled to the motor 24, and fan blades 224 arranged around the periphery of the hub 222. The motor 24 has a center shaft 242. The center shaft 242 has one end, namely, the top end inserted through the center coupling 182 of the wire guard 18 and fastened to the bottom end of the connecting tube 14 so that the motor 24 can rotate the fan member 22.

The rack 30 has a center through hole 32 coupled to the other end, namely, the bottom end of the center shaft 242 of the motor 24. The two distal ends of the rack 30 are fastened to the shade 60.

The lamp holder 40 is fastened to the bottom side of the rack 30, holding a lamp bulb 42.

The shade 60 can be made in any of a variety of shapes. According to this embodiment, the shade 60 is a semispherical member, having a shade body 62 with a plurality of slots 68, and a bearing portion 64. The shade body 62 has a broad top side and a narrow bottom side, defining a receiving space therein. The shade body 62 is adapted to accommodate the power unit 20, keeping the power unit 20 from sight. The bearing portion 64 is fixedly provided around the border area of the shade body 62 for the connection of the wire guard 18 of the mounting unit 10. The slots 68 are formed in the shade body 62 in communication between the receiving space defined by the shade body 64 and the space outside the shade 60 and sloping obliquely downwards for guiding air flow induced by the fan member 22 obliquely downwardly to the outside of the ceiling fan 1.

When started the motor 18 to rotate the fan member 22, the rotary motion of the fan member 22 causes air flow, which are guided obliquely downwardly to the outside of the ceiling fan 1 through the slots 68. Because the shade 60 keeps the power unit 20 from sight, the part of the ceiling fan 1 that is exposed to the outside causes a sense of beauty.

FIG. 3 is a perspective view of a ceiling fan 1A in accordance with a second preferred embodiment of the present invention. According to this embodiment, the shade 60A has a semispherical shade body 62A formed of a plurality of arched plates with a plurality of slots 68A for guiding air flow induced by the fan body (not shown) obliquely downwardly to the outside of the ceiling fan 1A, and a bottom rim 64A that holds the arched plates of the semispherical shade body 62A together.

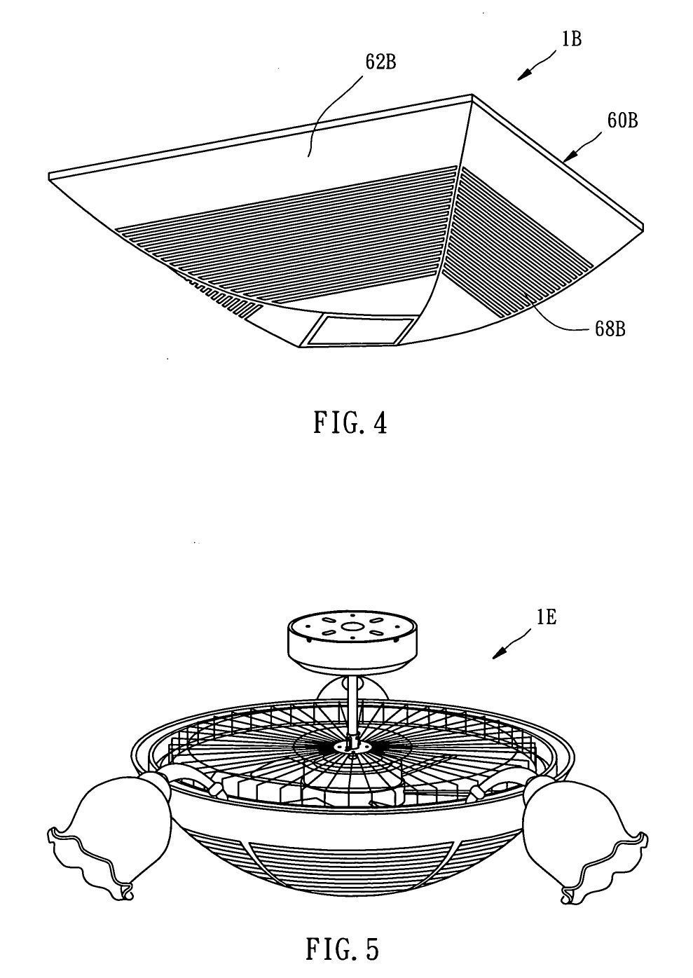

FIG. 4 is a perspective view of a ceiling fan 1B in accordance with a third preferred embodiment of the present invention. According to this embodiment, the shade 60B has a conical shape, defining a conical shade body 62B provided with a plurality of slots 68B for guiding induced air flow obliquely downwardly to the outside of the ceiling fan 1B.

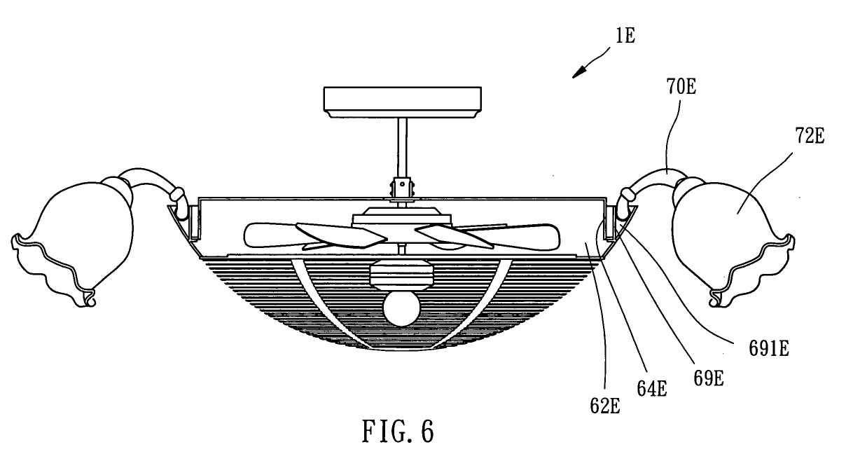

FIGS. 5 and 6 show a ceiling fan 1E in accordance with a fourth preferred embodiment of the present invention. According to this embodiment, a locating flange 69E is provided between the open side of the shade body 62E and the bearing portion 64E, defining with the shade body 62E a locating groove 691E for the mounting of a plurality of lamps 70E. The lamps 70E each have an end received in the locating groove 691E, and a decorative lampshade 72E at the other end.

In general, the invention provides a ceiling fan, which has the following benefits:

1. The shade keeps the power unit from sight, thereby greatly lowering the stress to the user.

2. The shade has slots sloping obliquely downwards for guiding induced air flow downwardly to the outside of the ceiling fan.

3. Different designs of shade may be provided so that the consumer can selectively attach the desired shade to the ceiling fan or regularly replace the shade as desired.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A ceiling fan comprising:
a mounting unit for fastening to a ceiling;
a power unit having a motor fastened to said mounting unit and a fan member coupled to and rotatable by said motor; and
a shade having a shade body accommodating therein said power unit, the shade body having a plurality of slots for guiding air flow induced by said fan member out of the shade.

2. The ceiling fan as claimed in claim 1, wherein said mounting unit comprises a hanging member for fastening to a ceiling, a connecting tube vertically downwardly extending from said hanging member, and a wire guard fastened to a bottom end of said connecting tube remote from said hanging member.

3. The ceiling fan as claimed in claim 1, further comprising a rack fastened to said power unit and said shade, and a lamp holder fastened to a bottom side of said rack for holding a lamp bulb inside said shade.

4. The ceiling fan as claimed in claim 1, wherein said shade body of the shade has a semispherical shape and is formed of a plurality of arched plates.

5. The ceiling fan as claimed in claim 1, wherein said shade has a conical shape.

6. The ceiling fan as claimed in claim 1, further comprising at least one lamp fastened to said shade for illumination.

7. A ceiling fan comprising:
a mounting unit for fastening to a ceiling;
a power unit having a motor fastened to said mounting unit and a fan member coupled to and rotatable by said motor;
a shade having a shade body having a broad top side and a narrow bottom side and defining a receiving space therein for accommodating said power unit, the shade body having a plurality of slots for guiding air flow induced by said fan member out of the shade; and
a plurality of lamps mounted around said shade for illumination.

8. The ceiling fan as claimed in claim 7, wherein said mounting unit comprises a hanging member for fastening to a ceiling, a connecting tube vertically downwardly extending from said hanging member, and a wire guard fastened to a bottom end of said connecting tube remote from said hanging member.

9. The ceiling fan as claimed in claim 7, further comprising a rack fastened to said power unit and said shade, and a lamp holder fastened to a bottom side of said rack for holding a lamp bulb inside said shade.

10. The ceiling fan as claimed in claim 7, wherein said shade has a locating flange located in said receiving space and defining with the said shade body a locating groove for receiving an end of each of the lamps.
